(19) United States
(12) Patent Application Publication
(10) Pub. No.: US 2022/0001262 A1
(43) Pub. Date: Jan. 6, 2022

(54) FITNESS MOTION RECOGNITION METHOD AND SYSTEM, AND ELECTRONIC DEVICE

(71) Applicant: SHENZHEN INSTITUTES OF ADVANCED TECHNOLOGY, SHENZHEN (CN)

(72) Inventors: Guoru Zhao, Shenzhen (CN); Yunkun Ning, Shenzhen (CN); Huiqi Li, Shenzhen (CN)

(21) Appl. No.: 17/481,323

(22) Filed: Sep. 22, 2021

Related U.S. Application Data
(63) Continuation of application No. PCT/CN2019/130588, filed on Dec. 31, 2019.

(51) Int. Cl. A63B 71/06

(52) U.S. Cl. CPC A63B 71/0686; A63B 2220/17; A63B 2220/34; A63B 2220/803; A63B 2220/62; A63B 2220/836; A63B 2230/06; A63B 2220/40

(57) ABSTRACT

A fitness motion recognition method and system, as well as an electronic device are disclosed. The fitness motion recognition method includes: collecting motion data and heart rate data of a human body during motion using a nine-axis inertial sensor and a heart rate sensor, respectively; calculating a resultant acceleration, a resultant angular velocity, and a roll angle of the nine-axis inertial sensor, as well as a real-time heart rate value using a motion recognition algorithm based on the motion data and heart rate data; and recognizing the fitness motion based on characteristics of the resultant acceleration, the resultant angular velocity and the roll angle of the nine-axis inertial sensor, and the real-time heart rate value.

### CROSS-REFERENCE TO RELATED APPLICATIONS

This application is a U.S. continuation of co-pending International Patent Application Number PCT/CN2019/130588, filed on Dec. 31, 2019, which claims the benefit and priority of Chinese Patent Application Number 201910285229.7, filed on Apr. 10, 2019, with China National Intellectual Property Administration, the disclosures of which are incorporated herein by reference in their entireties.

### TECHNICAL FIELD

This application relates to the technical field of motion state recognition, and more particularly relates to a fitness motion recognition method and system, as well as an electronic device.

### BACKGROUND

Nowadays, the recognition of the state of motion can be divided into the following two categories depending on different types of data studied:

1) Motion state recognition based on image and video. This method mainly captures the motion category of the human body by analyzing and digging into the data collected by the camera. Since the data collected by the camera is easily affected by factors such as weather, light, distance, orientation, etc., the scenes where it can be used are also very limited, and the video images take up storage space and so cannot be used for long periods of time.

2) Motion state recognition based on wearable device. This method mainly collects data from the sensor in the wearable device carried around and then analyzes and studies the data. Compared with the motion state recognition method based on image and video, this method has the following advantages: a. Low cost and easy to carry around—the wearable device is cheap and compact and can be worn on the body; b. Strong anti-interference—the external environment has little impact on the data collection process; c. Capability of continuously obtaining data—carrying it around can ensure continuous data acquisition.

However, the existing motion state recognition based on wearable devices all rely on inertial sensors for motion data collection, hence limited capability of judging the motion state, and it is impossible to accurately distinguish between fast running and jogging. Furthermore, the current motion state recognition is all intended for the daily routine activities of the human body, such as walking, running, standing up, sitting down, etc., but not for the fitness crowd.

Chinese patent application number 201410306132.7 discloses a method and device for analyzing human body motion based on heart rate and acceleration sensors. The device can detect motion states where the body movements are not obvious, such as weightlifting, strength training, and yoga. This patent application is a human body motion analysis method based on heart rate and acceleration sensors, which can effectively detect various aerobic and anaerobic exercises and sleep, and can prevent misjudgments due to waving hands and folding quilts. However, this patent application merely uses these data to distinguish whether the human body is in a state of motion or a non-motion, it cannot determine what the human body is doing, which however cannot effectively reflect the human body's motion status.

### SUMMARY

The present application provides a fitness motion recognition method and system, as well as an electronic device, which are intended to solve at least to a certain extent one of the above technical problems in the related art.

In order to solve the above problems, this application provides the following technical solutions.

There is provided a fitness motion recognition method, including the following operations:

operation a: collecting the motion data and heart rate data of the human body during movement through a nine-axis inertial sensor and a heart rate sensor;

operation b: calculating a resultant acceleration, a resultant angular velocity, and a roll angle of the nine-axis inertial sensor, as well as a real-time heart rate value using a motion recognition algorithm based on the motion data and heart rate data; and

operation c: recognizing the fitness motion based on the characteristics of the resultant acceleration, the resultant angular velocity and the roll angle of the nine-axis inertial sensor, and the real-time heart rate value.

The technical solution adopted in the embodiments of the application may further include: in operation a, calculating the resultant acceleration, the resultant angular velocity, the roll angle, and the real-time heart rate value of the nine-axis inertial sensor using the motion recognition algorithm based on the motion data and the heart rate data may specifically include: filtering the collected heart rate data to remove motion artifacts to obtain a real-time heart rate value, the real-time heart rate value including the maximum exercise heart rate, the minimum exercise heart rate, and the resting heart rate.

The technical solution adopted in the embodiments of the application may further include: in operation a, calculating the resultant acceleration, the resultant angular velocity, and the roll angle of the nine-axis inertial sensor, as well as the real-time heart rate value using the motion recognition algorithm based on the motion data and the heart rate data may further include: calibrating and filtering the collected motion data to obtain three-axis acceleration, three-axis angular velocity, and three-axis magnetometer data; fusing the three-axis acceleration, the three-axis angular velocity, and the three-axis magnetometer data to obtain the resultant acceleration, the resultant angular velocity, and the quaternion required for attitude calculation.

The technical solution adopted in the embodiments of the application may further include: in operation a, calculating the resultant acceleration, the resultant angular velocity, and the roll angle of the nine-axis inertial sensor, as well as the real-time heart rate value using the motion recognition algorithm based on the motion data and the heart rate data may further include: fusing the three-axis acceleration, the three-axis angular velocity, and the three-axis magnetometer data to obtain the resultant acceleration, the resultant angular velocity, and the quaternion required for attitude calculation; and converting the quaternion to obtain attitude angle, roll angle, and heading angle data.

The technical solution adopted in the embodiments of the application may further include: after operation c, further included is: timing or counting the fitness motion according to the fitness motion recognition result, and performing a reminder operation according to the set threshold time period or threshold number of times.

Another technical solution adopted in the embodiments of the present application is a fitness motion recognition system, including:

an inertial sensor module configured for collecting the motion data of the human body during movement through a nine-axis inertial sensor;

a heart rate sensor module configured for collecting heart rate data of the human body during movement through a heart rate sensor;

a motion recognition algorithm module configured for calculating a resultant acceleration, a resultant angular velocity, and the roll angle of the nine-axis inertial sensor, as well as the real-time heart rate value using a motion recognition algorithm based on the motion data and heart rate data

a fitness motion recognition module configured for recognizing the fitness motion based on the characteristics of the resultant acceleration, the resultant angular velocity and the roll angle of the nine-axis inertial sensor, and the real-time heart rate value.

In a further technical solution adopted in the embodiments of the application. The motion recognition algorithm module may include:

a heart rate data processing unit configured for filtering the collected heart rate data to remove motion artifacts to obtain a real-time heart rate value, the real-time heart rate value including the maximum exercise heart rate, the minimum exercise heart rate, and the resting heart rate.

In a further technical solution adopted in the embodiments of the application. The motion recognition algorithm module may include:

a motion data processing unit configured for calibrating and filtering the collected motion data to obtain three-axis acceleration, three-axis angular velocity, and three-axis magnetometer data; and

a data fusion unit configured for fusing the three-axis acceleration, three-axis angular velocity, and three-axis magnetometer data to obtain the resultant acceleration, the resultant angular velocity, and the quaternion required for attitude calculation.

In a further technical solution adopted in the embodiments of the application. The motion recognition algorithm module may include:

a data conversion unit configured for converting the quaternion to obtain attitude angle, roll angle, and heading angle data.

The technical solution adopted in the embodiments of this application may further include:

a fitness reminder module configured for timing or counting the fitness motion according to the fitness motion recognition result, and performing a reminder operation according to the set threshold time period or threshold number of times.

Another technical solution adopted by the embodiments of the present application is an electronic device, including:

at least one processor; and

a memory communicatively coupled with the at least one processor;

wherein the memory stores instructions executable by the at least one processor, and the instructions when executed by the at least one processor cause the at least one processor to execute the following operations of the fitness motion recognition method described above:

operation a: collecting the motion data and heart rate data of the human body during movement through a nine-axis inertial sensor and a heart rate sensor;

operation b: calculating a resultant acceleration, a resultant angular velocity, and a roll angle of the nine-axis inertial sensor, as well as a real-time heart rate value using a motion recognition algorithm based on the motion data and heart rate data;

and

operation c: recognizing the fitness motion based on the characteristics of the resultant acceleration, the resultant angular velocity and the roll angle of the nine-axis inertial sensor, and the real-time heart rate value.

Compared with the related art, embodiments of the present application may bring the following beneficial effects. According to the fitness motion recognition method and system, as well as the electronic device provided by the embodiments of the present application, the exercise data and heart rate data are collected by a nine-axis inertial sensor and a heart rate sensor that are worn on the human body, and an exercise state recognition algorithm is designed based on the exercise data and heart rate data. Through the real-time data collection, the processor uses the motion recognition algorithm to recognize fitness motions based on the characteristics of the exercise data and real-time heart rate data, and clearly recognizes fast running and jogging, which can improve the fitness efficiency of the fitness crowd, thus guiding the training of the fitness crowd in a better and more convenient manner.

### BRIEF DESCRIPTION OF DRAWINGS

FIG. 1 is a flowchart illustrating a fitness motion recognition method according to an embodiment of the present application.

FIG. 2 is a schematic diagram illustrating the characteristics of the Burpee Exercise.

FIG. 3 is a schematic diagram illustrating the characteristics of the pull-up exercise.

FIG. 4 is a schematic diagram illustrating the characteristics of the squatting exercise.

FIG. 5 is a schematic diagram illustrating the characteristics of sit-up exercise.

FIG. 6 is a schematic diagram illustrating the characteristics of the high knees lift exercise.

FIG. 7 is a schematic diagram illustrating the characteristics of the jumping jack exercise.

FIG. 8 is a schematic diagram illustrating the characteristics of the deadlift exercise.

FIG. 9 is a schematic diagram illustrating the characteristics of the running exercise.

FIG. 10 is a hardware system framework diagram illustrating the fitness motion recognition system according to an embodiment of the present application.

FIG. 11 is a block diagram illustrating a fitness motion recognition system according to an embodiment of the present application.

FIG. 12 is a schematic diagram illustrating the hardware structure implementing the fitness motion recognition method provided by an embodiment of the present application.

### DETAILED DESCRIPTION OF ILLUSTRATIVE EMBODIMENTS

For a better understanding of the objectives, technical solutions, and advantages of the present application, hereinafter the present application will be described in further detail in connection with the accompanying drawings and some illustrative embodiments. It is to be understood that the specific embodiments described here are intended for the mere purposes of illustrating this application, instead of limiting.

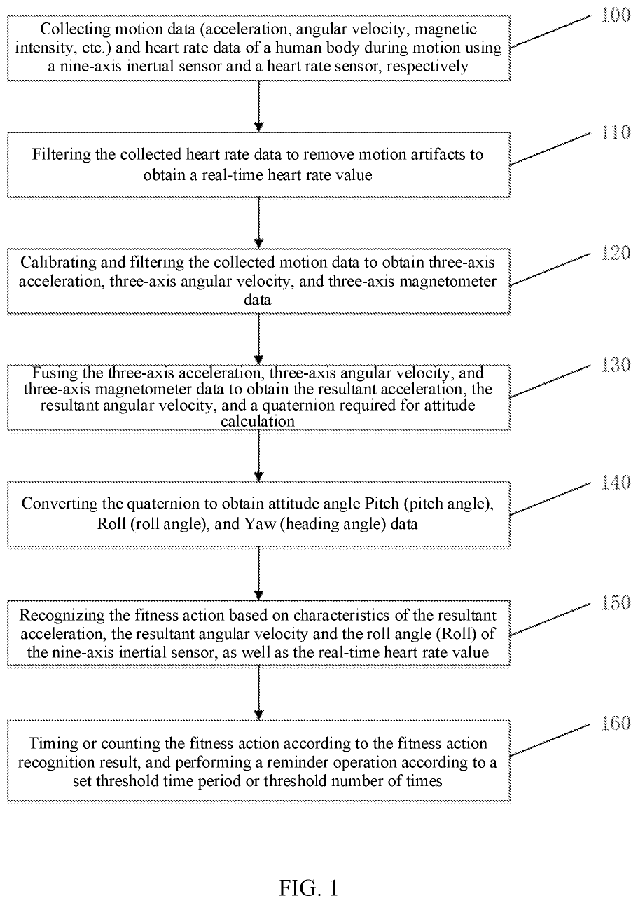

FIG. 1 is a flowchart illustrating a fitness motion recognition method according to an embodiment of the present application. The fitness motion recognition method according to this embodiment of the present application may include the following operations.

In operation 100, the method may include collecting the motion data (acceleration, angular velocity, magnetic intensity, etc.) and heart rate data of the human body during movement through a nine-axis inertial sensor and a heart rate sensor;

In operation 100, the motion data collection is achieved by STM32 and MPU9250, where STM32 and MPU9250 are coupled through the IIC bus. The MCU is set through the corresponding registers of MPU9250, including registers such as sampling rate and sensor range. In this embodiment of the application, the default acceleration range is ±8 g, the gyroscope is ±1000 dbps, and the magnetometer works in single measurement mode, which can be set according to actual operations. Each sensor can output 6 bytes of data in one sampling operation. The output of the three axes of each sensor occupies 2 bytes with each axis, with the high bit ranking first. The heart rate data collection is performed by STM32 and the heart rate sensor. The heart rate sensor is connected to the STM32 through the IIC bus, and its registers are configured thereby.

In operation 110, the method may include filtering the collected heart rate data to remove motion artifacts to obtain a real-time heart rate value.

In operation 110, the heart rate value is calculated by:

Maximum exercise heart rate=(220−current age)*0.8;

Minimum exercise heart rate=(220−current age)*0.6;

Normal resting heart rate is generally 60-100 beats/min for adults. When the human body is in a resting state, (hᵢ) is recorded once every 10 seconds according to the heart rate sensor data and recorded 5 times in a row to find the average value, which is then multiplied by 6 to get the resting heart rate per minute (heart):

$$heart = \frac{{\sum }_{i = 1}^{5} {h}_{i}}{5} \qquad ( 1 )$$

In operation 120, the method may include calibrating and filtering the collected motion data to obtain three-axis acceleration, three-axis angular velocity, and three-axis magnetometer data.

In operation 130, the method may include fusing the three-axis acceleration, three-axis angular velocity, and three-axis magnetometer data to obtain the resultant acceleration, the resultant angular velocity, and the quaternion required for attitude calculation.

In operation 130, the purpose of data fusion is to obtain the quaternion required for the attitude calculation. The quaternion has a small calculation overhead, has no singularities, and can meet the real-time calculation of the attitude of the aircraft during movement. For a certain vector, when it is expressed in different coordinate systems, the size and direction they represent must be the same, but due to the error present in the rotation matrix of the two coordinate systems, when a vector passes through a rotation matrix with an error, there will be a deviation from the theoretical value in another coordinate system. The system can correct the rotation matrix through this deviation. The elements of the rotation matrix are quaternions, and the corrected quaternion can be converted into an attitude angle with a smaller error.

Three-axis acceleration values Accx, Accy, Accz, and the resultant acceleration Accsum:

Accsum=\sqrt{Accx²+Accy²+Accz²} (2)

Three-axis angular velocities Gyrx, Gyry, Gyrz, and the resultant angular velocity Gyrsum:

Gyrsum=\sqrt{Gyrx²+Gyry²+Gyrz²} (3)

In operation 140, the method may include converting the quaternion to obtain the attitude angle Pitch (pitch angle), Roll (roll angle), and Yaw (heading angle) data, separately.

In operation 150, the method may include recognizing the fitness motion based on the characteristics of the resultant acceleration, the resultant angular velocity and the roll angle (Roll), and the real-time heart rate value.

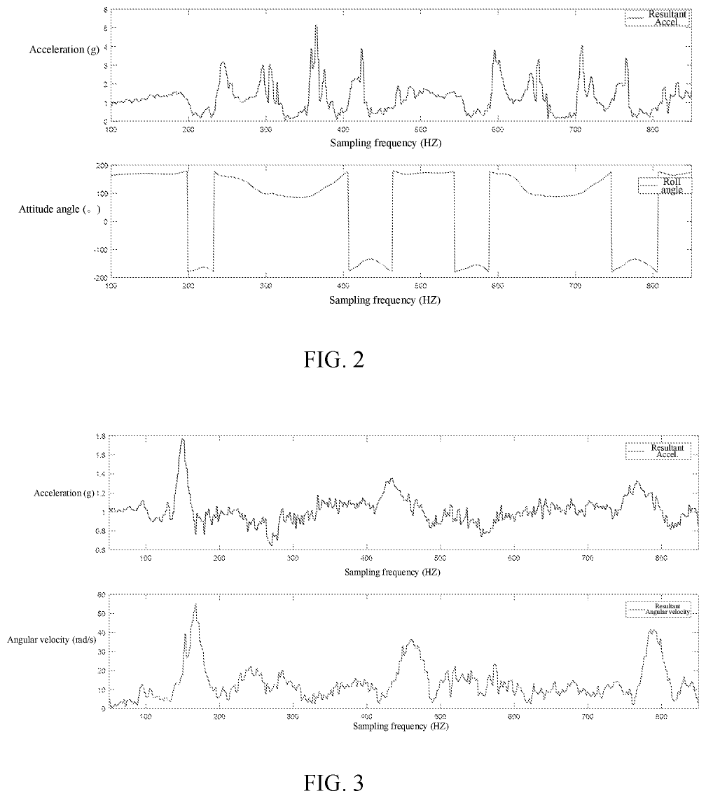

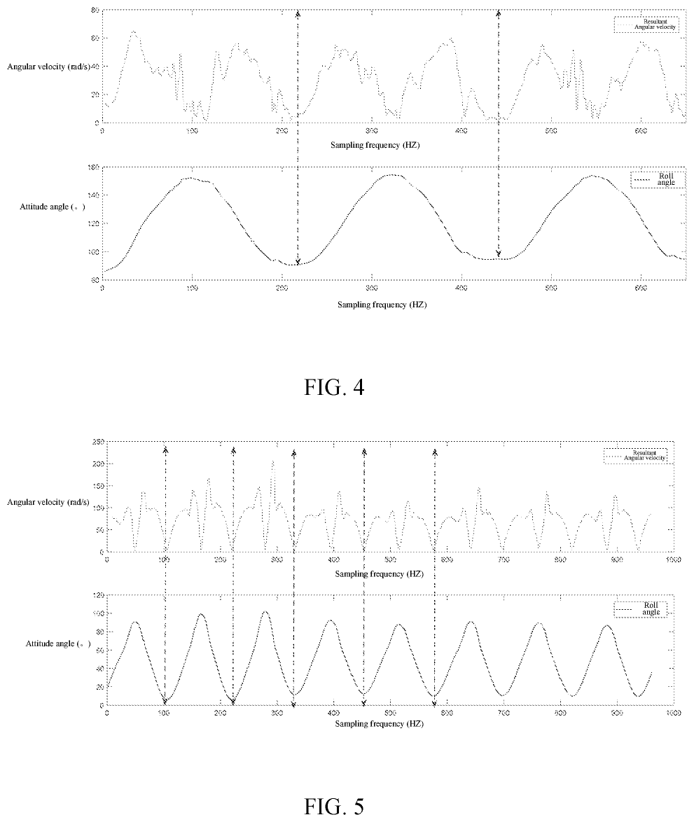

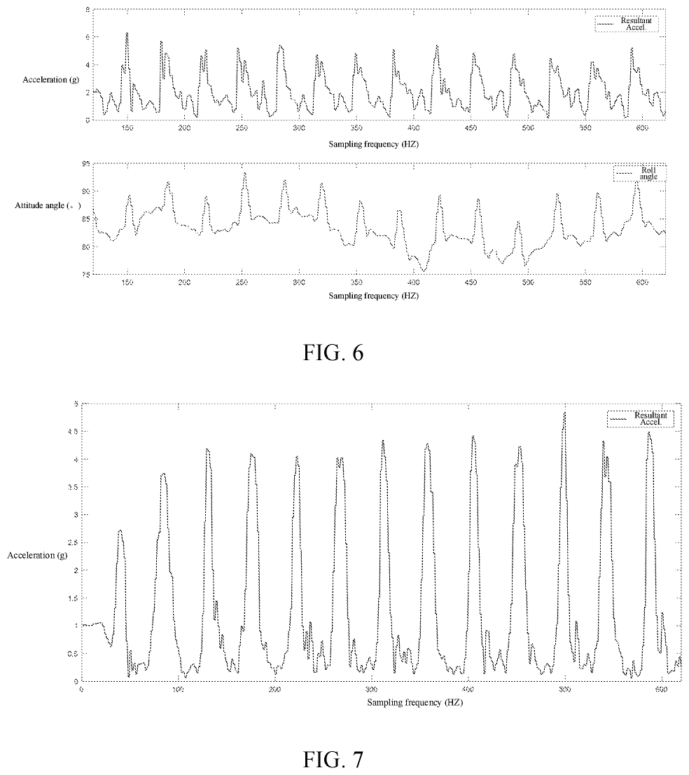

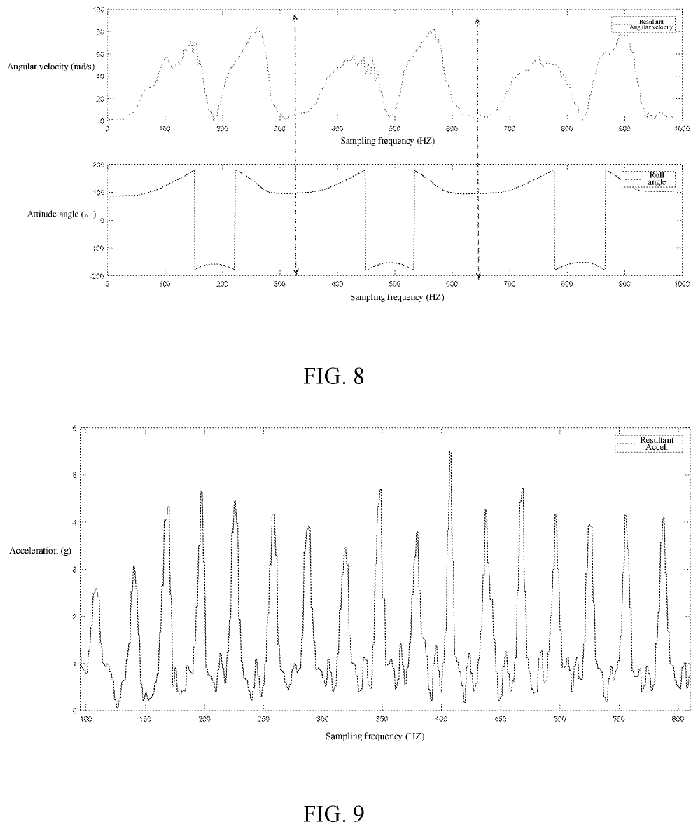

In operation 150, the characteristics of the resultant acceleration, the resultant angular velocity, and the roll angle (Roll), as well as the heart rate value corresponding to each fitness motion are different. Hereinafter, exercises including the Burpee exercise, pull-ups, squats, sit-ups, high knees lifts, jumping jack exercise, deadlifts, and running (fast running and jogging) exercise are taken as examples for illustration. FIGS. 2 to 9 respectively illustrate the characteristics of the Burpee exercise, pull-ups, squats, sit-ups, high knees lifts, jumping jack exercise, deadlifts, and running (fast running and jogging) exercise. As illustrated in FIG. 2, upon the completion of each Burpee action, there will be four peaks in the resultant acceleration and two troughs in the Roll angle. As illustrated in FIG. 3, which show three pull-ups collected in the experiment, where it can be seen that both the resultant acceleration and the resultant angular velocity each have three peaks. As illustrated in FIG. 4, upon the completion of each squat movement, two peaks will appear in the resultant angular velocity, and one peak will appear in the Roll angle simultaneously. As illustrated in FIG. 5, until each sit-up action is completed, there will be a peak in the Roll angle, and at the same time two consecutive peaks will appear in the resultant angular velocity. As illustrated in FIG. 6, until each high knees lift action is completed, both the resultant acceleration and the roll angle will experience peaks that appear at short intervals of time. As illustrated in FIG. 7, every time the jumping jack action is completed, there will be a peak in the resultant acceleration. As illustrated in FIG. 8, after every deadlift is completed, the Roll angle will experience a trough, and at the same time, the resultant angular velocity will experience two peaks. As illustrated in FIG. 9, the resultant acceleration will experience periodical peaks during running. In the experiment, a set of heart rates is separately collected for both fast running and jogging. In fast running, the heart rate reaches 125 beats/min, and in jogging, the heart rate reaches 99 beats/min. Therefore, fast running and jogging can be distinctly recognized in view of the real-time heart rate value.

In operation 160, the method may include performing a corresponding timing/counting operation according to the fitness motion recognition result, and performing a reminder operation according to the set time/number threshold.

In operation 160, take Burpee, pull-ups, squats, sit-ups, high knees lifts, jumping jack, deadlifts, and running exercises as examples. When the fitness motion recognition result is Burpee, jumping jack, high knees lifts, or running, timing is performed, and a reminder is given once when the timing reaches the set timing threshold (in this embodiment of the application, the timing threshold is set to one minute, which can of course be set according to actual operations). When the fitness motion recognition result is deadlift, pull-ups, squats or sit-ups, then counting is performed, and when the count reaches the set count threshold (in this embodiment of the application, the count threshold is set to 10 times, which can of course be set according to actual operations).

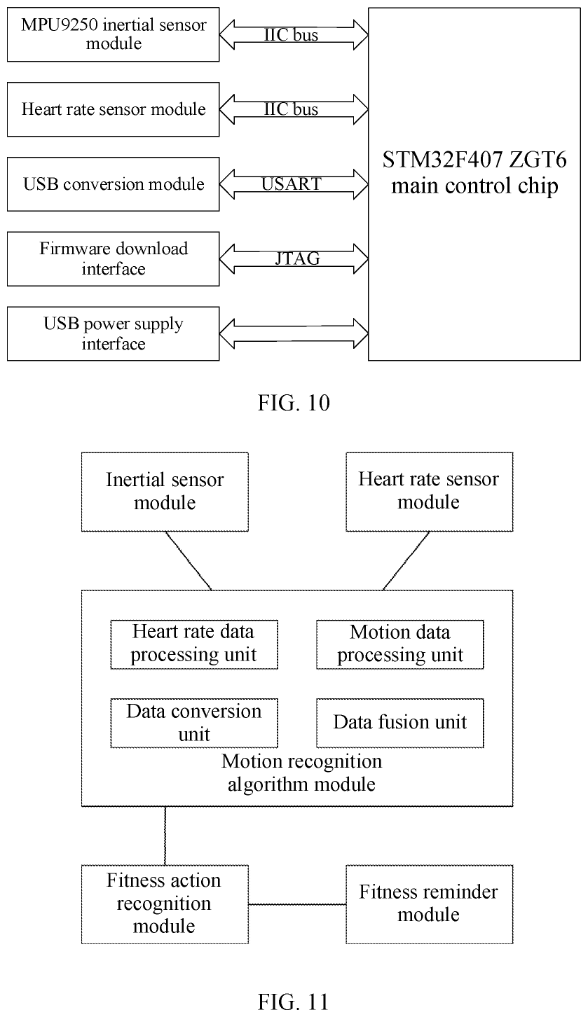

FIG. 10 is a hardware system framework diagram illustrating the fitness motion recognition system according to an embodiment of the present application. The hardware system includes an inertial sensor module, a heart rate sensor module, a USB conversion module, a firmware download interface, a USB power supply interface, and a main control module. The main control module adopts STM32F407ZGT6 chip, with a main frequency of up to 168 MHZ, and 1 MB FLASH and 192 KB SRAM which provide fast operation and processing capabilities for running reliable and stable wireless sensor network programs and realizing high-speed real-time storage of data. It further uses an LQFP144 ultra-small package which realizes miniaturization of the entire sensor node. There are further provided up to 14 timers, 3 IIC interfaces, 3 SPI interfaces, 6 USART interfaces, 3 ADCs, 2 DACs, 112 general-purpose IO ports, etc., which provide an extremely rich data communication interfaces for connecting to peripherals. The main control module has a built-in JTAG interface, and programs can be downloaded and debugged through the firmware download interface.

The USB conversion module uses the CP2102 chip, and uses the communication protocol USART with the main control module, which has the characteristics of high integration. It can have a built-in USB2.0 full-speed function controller, USB transceiver, crystal oscillator, EEPROM, and asynchronous serial data bus (UART). It supports the modem's full-function signal, does not need any external USB devices, and can fulfill the level conversion and communication control of the RS232 protocol and USB2.0 protocol of the USART interface of the sensor network node.

As the data source of the system, the inertial sensor module, IMU (Inertial Measurement Unit), needs to have high reliability, high stability and anti-interference capability. MPU9250 integrates 3-axis accelerator, 3-axis gyroscope and digital motion processor (DMP), and can directly output all 9-axis data via SPI or I2C. The range of the nine-axis data is programmable. The chip is packaged with QFN, which is conducive to reducing the volume of the entire system. Multi-range options can meet the requirements on the system for collecting data of various human movements. DMP provides a variety of data fusion methods for it. The low power consumption mode can reduce the power consumption of the system when it is in a static state, thus meeting the requirements of the system for low power consumption.

FIG. 11 is a block diagram illustrating a fitness motion recognition system according to an embodiment of the present application. The fitness motion recognition system according to this embodiment of the present application includes an inertial sensor module, a heart rate sensor module, a motion recognition algorithm module, a fitness motion recognition module, and a fitness reminder module.

The inertial sensor module is used to collect the motion data (acceleration, angular velocity, magnetic intensity, etc.) of the human body during the movement through a nine-axis inertial sensor. The motion data collection is achieved by STM32 and MPU9250, where STM32 and MPU9250 are coupled through the IIC bus. The MCU is set through the corresponding registers of MPU9250, including registers such as sampling rate and sensor range. In this embodiment of the application, the default acceleration range is ±8 g, the gyroscope is ±1000 dbps, and the magnetometer works in single measurement mode, which can be set according to actual operations. Each sensor can output 6 bytes of data in one sampling operation. The output of the three axes of each sensor occupies 2 bytes with each axis, with the high bit ranking first.

The heart rate sensor module is used to collect the heart rate data of the human body through the heart rate sensor. The heart rate data collection is performed by STM32 and the heart rate sensor. The heart rate sensor is connected to the STM32 through the IIC bus, and its registers are configured thereby.

The motion recognition algorithm module is used for calculating a resultant acceleration, a resultant angular velocity, and a roll angle of the nine-axis inertial sensor, as well as a real-time heart rate value using a motion recognition algorithm based on the motion data and heart rate data. In particular, the motion recognition algorithm module may include:

The heart rate data processing unit is used to filter the collected heart rate data, remove motion artifacts, so as to obtain real-time heart rate values, where the heart rate value is calculated by:

Maximum exercise heart rate=(220−current age)*0.8;

Minimum exercise heart rate=(220−current age)*0.6;

Normal resting heart rate is generally 60-100 beats/min for adults. When the human body is in a resting state, (hᵢ) is recorded once every 10 seconds according to the heart rate sensor data and recorded 5 times in a row to find the average value, which is then multiplied by 6 to get the resting heart rate per minute (heart):

$$heart = \frac{{\sum }_{i = 1}^{5} {h}_{i}}{5} \qquad ( 1 )$$

The motion data processing unit is used for calibrating and filtering the collected motion data to obtain three-axis acceleration, three-axis angular velocity, and three-axis magnetometer data.

The data fusion unit is used to fuse the three-axis acceleration, three-axis angular velocity, and three-axis magnetometer data to obtain the resultant acceleration, the resultant angular velocity and the quaternion required for attitude calculation. The purpose of data fusion is to obtain the quaternion required for the attitude calculation. The quaternion has a small calculation overhead, has no singularities, and can meet the real-time calculation of the attitude of the aircraft during movement. For a certain vector, when it is expressed in different coordinate systems, the size and direction they represent must be the same, but due to the error present in the rotation matrix of the two coordinate systems, when a vector passes through a rotation matrix with an error, there will be a deviation from the theoretical value in another coordinate system. The system can correct the rotation matrix through this deviation. The elements of the rotation matrix are quaternions, and the corrected quaternion can be converted into an attitude angle with a smaller error.

Three-axis acceleration values Accx, Accy, Accz, and the resultant acceleration Accsum:

Accsum=\sqrt{Accx²+Accy²+Accz²} (2)

Three-axis angular velocities Gyrx, Gyry, Gyrz, and the resultant angular velocity Gyrsum:

Gyrsum=\sqrt{Gyrx²+Gyry²+Gyrz²} (3)

The data conversion unit is used for converting the quaternion to obtain the attitude angle Pitch (pitch angle), Roll (roll angle), and Yaw (heading angle) data, separately.

The fitness motion recognition module is used to recognize the fitness motion based on the characteristics of the resultant acceleration, the resultant angular velocity, and the roll angle (Roll), as well as the real-time heart rate value. The characteristics of the resultant acceleration, the resultant angular velocity, and the roll angle (Roll), as well as the heart rate value corresponding to each fitness motion are different. Hereinafter, exercises including the Burpee exercise, pull-ups, squats, sit-ups, high knees lifts, jumping jack exercise, deadlifts, and running (fast running and jogging) exercise are taken as examples for illustration. FIGS. 2 to 9 respectively illustrate the characteristics of the Burpee exercise, pull-ups, squats, sit-ups, high knees lifts, jumping jack exercise, deadlifts, and running exercise. As illustrated in FIG. 2, upon the completion of each Burpee action, there will be four peaks in the resultant acceleration and two troughs in the Roll angle. As illustrated in FIG. 3, which show three pull-ups collected in the experiment, where it can be seen that the resultant angular velocity has three peaks. As illustrated in FIG. 4, upon the completion of each squat movement, one peak will appear in the resultant angular velocity, and one peak will appear in the Roll angle simultaneously. As illustrated in FIG. 5, until each sit-up action is completed, there will be a peak in the Roll angle, and at the same time two consecutive peaks will appear in the resultant angular velocity. As illustrated in FIG. 6, until each high knees lift action is completed, the resultant acceleration will experience peaks that appear at short intervals. As illustrated in FIG. 7, every time the jumping jack action is completed, there will be a peak in the resultant acceleration. As illustrated in FIG. 8, after every deadlift is completed, the Roll angle will experience a trough, and at the same time the resultant angular velocity will experience peaks. As illustrated in FIG. 9, the resultant acceleration will experience periodical peaks during running. In the experiment, a set of heart rates is separately collected for both fast running and jogging. In fast running, the heart rate reaches 125 beats/min, and in jogging, the heart rate reaches 99 beats/min. Therefore, fast running and jogging can be distinctly recognized in view of the real-time heart rate value.

The fitness reminder module is used for performing a corresponding timing/counting operation according to the fitness motion recognition result, and performing a reminder operation according to the set time/number threshold. Take Burpee, pull-ups, squats, sit-ups, high knees lifts, jumping jack, deadlifts, and running exercises as examples. When the fitness motion recognition result is Burpee, jumping jack, high knees lifts, or running, timing is performed, and a reminder is given once when the timing reaches the set timing threshold (in this embodiment of the application, the timing threshold is set to one minute, which can of course be set according to actual operations). When the fitness motion recognition result is deadlift, pull-ups, squats or sit-ups, then counting is performed, and when the count reaches the set count threshold (in this embodiment of the application, the count threshold is set to 10 times, which can of course be set according to actual operations).

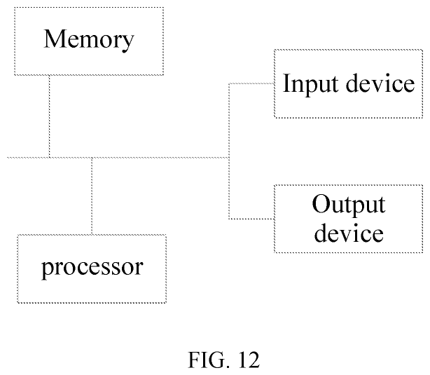

FIG. 12 is a schematic diagram illustrating the hardware structure implementing the fitness motion recognition method provided by an embodiment of the present application. As illustrated in FIG. 12, the device includes one or more processors and a memory. Taking one processor as an example, the device may further include an input system and an output system.

The processor, the memory, the input system, and the output system may be coupled by a bus or by other ways. In FIG. 12, the connection by a bus is illustrated as an example.

As a non-transitory computer-readable storage medium, the memory can be used to store non-transitory software programs, non-transitory computer executable programs and modules. The processor can execute various functional applications and data processing of the electronic device by running the non-transitory software programs, instructions, and modules stored in the memory, thus realizing the processing methods of the foregoing method embodiments.

The memory may include a program storage area and a data storage area, where the program storage area can store an operating system and an application program required by at least one function, while the data storage area can store data and the like. In addition, the memory may include a high-speed random access memory, and may also include a non-transitory memory, such as at least one magnetic disk storage device, a flash memory device, or other non-transitory solid-state storage devices. In some embodiments, the memory may optionally include a memory remotely arranged with respect to the processor, and these remote memories may be connected to the processing system through a network. Examples of the aforementioned network include, but are not limited to, the Internet, corporate intranets, local area networks, mobile communication networks, and combinations thereof.

The input system can receive input digital or character information, and generate a signal input. The output system may include display devices such as a display screen.

The one or more modules are stored in the memory, and when executed by the one or more processors, the following operations of any of the foregoing method embodiments are performed:

operation a: collecting the motion data and heart rate data of the human body during movement through a nine-axis inertial sensor and a heart rate sensor;

operation b: calculating a resultant acceleration, a resultant angular velocity, and a roll angle of the nine-axis inertial sensor, as well as a real-time heart rate value using a motion recognition algorithm based on the motion data and heart rate data; and

operation c: recognizing the fitness motion based on the characteristics of the resultant acceleration, the resultant angular velocity and the roll angle of the nine-axis inertial sensor, and the real-time heart rate value.

The above-mentioned product can execute the methods provided in the embodiments of the present application, and have functional modules and beneficial effects corresponding to the executable methods. For technical details that are not described in detail in this embodiment, referring to the methods provided in the embodiments of this application.

Embodiments of the present application further provide a non-transitory (non-volatile) computer storage medium, which stores computer executable instructions, which can perform the following operations:

operation a: collecting the motion data and heart rate data of the human body during movement through a nine-axis inertial sensor and a heart rate sensor;

operation b: calculating a resultant acceleration, a resultant angular velocity, and a roll angle of the nine-axis inertial sensor, as well as a real-time heart rate value using a motion recognition algorithm based on the motion data and heart rate data; and

operation c: recognizing the fitness motion based on the characteristics of the resultant acceleration, the resultant angular velocity and the roll angle of the nine-axis inertial sensor, and the real-time heart rate value.

Embodiments of the present application further provide a computer program product, which includes a computer program stored on a non-transitory computer-readable storage medium, the computer program includes program instructions, which when executed by a computer cause the computer to perform the following operations:

operation a: collecting the motion data and heart rate data of the human body during movement through a nine-axis inertial sensor and a heart rate sensor;

operation b: calculating a resultant acceleration, a resultant angular velocity, and a roll angle of the nine-axis inertial sensor, as well as a real-time heart rate value using a motion recognition algorithm based on the motion data and heart rate data; and

operation c: recognizing the fitness motion based on the characteristics of the resultant acceleration, the resultant angular velocity and the roll angle of the nine-axis inertial sensor, and the real-time heart rate value.

According to the fitness motion recognition method and system, as well as the electronic device provided by the foregoing embodiments of the present application, the exercise data and heart rate data are collected by a nine-axis inertial sensor and a heart rate sensor that are worn on the human body, and an exercise state recognition algorithm is designed based on the exercise data and heart rate data. Through the real-time data collection, the processor uses the motion recognition algorithm to recognize fitness motions based on the characteristics of the exercise data and real-time heart rate data, and clearly recognizes fast running and jogging, which can improve the fitness efficiency of the fitness crowd, thus guiding the training of the fitness crowd in a better and more convenient manner.

The above description of the disclosed embodiments enables those having ordinary skill in the art to implement or use the present application. Various modifications to these embodiments will be evident to those having ordinary skill in the art, and the general principles defined in the present application may be implemented in other embodiments without departing from the spirit or scope of the present application. Therefore, the present application will not be limited to the embodiments disclosed herein, but should be interpreted to cover the widest scope consistent with the principles and novel features disclosed in the present application.

What is claimed is:

1. A fitness motion recognition method, comprising:
operation a: collecting motion data and heart rate data of a human body during motion using a nine-axis inertial sensor and a heart rate sensor, respectively;
operation b: calculating a resultant acceleration, a resultant angular velocity, and a roll angle of the nine-axis inertial sensor, as well as a real-time heart rate value using a motion recognition algorithm based on the motion data and heart rate data; and
operation c: recognizing the fitness motion based on characteristics of the resultant acceleration, the resultant angular velocity and the roll angle of the nine-axis inertial sensor, and the real-time heart rate value.

2. The fitness motion recognition method as recited in claim 1 wherein in operation b, calculating the resultant acceleration, the resultant angular velocity, and the roll angle of the nine-axis inertial sensor, as well as the real-time heart rate value using the motion recognition algorithm based on the motion data and the heart rate data respectively comprises: filtering the collected heart rate data to remove motion artifacts to obtain a real-time heart rate value, the real-time heart rate value comprising a maximum exercise heart rate, a minimum exercise heart rate, and a resting heart rate.

3. The fitness motion recognition method as recited in claim 2, wherein in operation b, calculating the resultant acceleration, the resultant angular velocity, and the roll angle of the nine-axis inertial sensor, as well as the real-time heart rate value using the motion recognition algorithm based on the motion data and the heart rate data respectively further comprises: calibrating and filtering the collected motion data to obtain three-axis acceleration, three-axis angular velocity, and three-axis magnetometer data; fusing the three-axis acceleration, three-axis angular velocity, and three-axis magnetometer data to obtain the resultant acceleration, the resultant angular velocity, and a quaternion required for attitude calculation.

4. The fitness motion recognition method as recited in claim 3, wherein in operation b, calculating the resultant acceleration, the resultant angular velocity, and the roll angle of the nine-axis inertial sensor, as well as the real-time heart rate value using the motion recognition algorithm based on the motion data and the heart rate data respectively further comprises: fusing the three-axis acceleration, three-axis angular velocity, and three-axis magnetometer data to obtain the resultant acceleration, the resultant angular velocity, and the quaternion required for attitude calculation; and converting the quaternion to obtain attitude angle, roll angle, and heading angle data.

5. The fitness motion recognition method as recited in claim 1, further comprising the following operation subsequent to operation c: timing or counting the fitness motion according to the fitness motion recognition result, and performing a reminder operation according to a set threshold time period or threshold number of times.

6. The fitness motion recognition method as recited in claim 2, further comprising the following operation subsequent to operation c: timing or counting the fitness motion according to the fitness motion recognition result, and performing a reminder operation according to a set threshold time period or threshold number of times.

7. The fitness motion recognition method as recited in claim 3, further comprising the following operation subsequent to operation c: timing or counting the fitness motion according to the fitness motion recognition result, and performing a reminder operation according to a set threshold time period or threshold number of times.

8. The fitness motion recognition method as recited in claim 4, further comprising the following operation subsequent to operation c: timing or counting the fitness motion according to the fitness motion recognition result, and performing a reminder operation according to a set threshold time period or threshold number of times.

9. A fitness motion recognition system, comprising:
an inertial sensor module, configured for collecting motion data of a human body during motion using a nine-axis inertial sensor;
a heart rate sensor module, configured for collecting heart rate data of the human body during motion using a heart rate sensor;
a motion recognition algorithm module, configured for calculating a resultant acceleration, a resultant angular velocity, a roll angle of the nine-axis inertial sensor, as well as a real-time heart rate value using a motion recognition algorithm based on the motion data and heart rate data; and
a fitness motion recognition module, configured for recognizing the fitness motion based on characteristics of the resultant acceleration, the resultant angular velocity, and the roll angle of the nine-axis inertial sensor, as well as the real-time heart rate value.

10. The fitness motion recognition system as recited in claim 9, wherein the exercise recognition algorithm module comprises:
a heart rate data processing unit, configured for filtering the collected heart rate data to remove motion artifacts to obtain a real-time heart rate value, the real-time heart rate value comprising a maximum exercise heart rate, a minimum exercise heart rate, and a resting heart rate.

11. The fitness motion recognition system as recited in claim 10, wherein the exercise recognition algorithm module comprises:
a motion data processing unit, configured for calibrating and filtering the collected motion data to obtain three-axis acceleration, three-axis angular velocity, and three-axis magnetometer data; and
a data fusion unit, configured for fusing the three-axis acceleration, three-axis angular velocity, and three-axis magnetometer data to obtain the resultant acceleration, the resultant angular velocity, and a quaternion required for attitude calculation.

12. The fitness motion recognition system as recited in claim 11, wherein the exercise recognition algorithm module comprises:
a data conversion unit, configured for converting the quaternion to obtain attitude angle, roll angle, and heading angle data.

13. The fitness motion recognition system as recited in claim 9, wherein the exercise recognition algorithm module comprises:
a fitness reminder module, configured for timing or counting the fitness motion according to the fitness motion recognition result, and performing a reminder operation according to a set threshold time period or threshold number of times.

14. The fitness motion recognition system as recited in claim 10, wherein the exercise recognition algorithm module comprises:
a fitness reminder module, configured for timing or counting the fitness motion according to the fitness motion recognition result, and performing a reminder operation according to a set threshold time period or threshold number of times.

15. The fitness motion recognition system as recited in claim 11, wherein the exercise recognition algorithm module comprises:
a fitness reminder module, configured for timing or counting the fitness motion according to the fitness motion recognition result, and performing a reminder operation according to a set threshold time period or threshold number of times.

16. The fitness motion recognition system as recited in claim 12, wherein the exercise recognition algorithm module comprises:
a fitness reminder module, configured for timing or counting the fitness motion according to the fitness motion recognition result, and performing a reminder operation according to a set threshold time period or threshold number of times.

17. An electronic device, comprising:
at least one processor; and
a memory communicatively coupled with the at least one processor;
wherein the memory stores instructions executable by the at least one processor, and wherein the instructions when executed by the at least one processor cause the at least one processor to execute the operations of the fitness motion recognition method as recited in claim 1.

18. The electronic device as recited in claim 17, wherein in operation b, calculating the resultant acceleration, the resultant angular velocity, and the roll angle of the nine-axis inertial sensor, as well as the real-time heart rate value using the motion recognition algorithm based on the motion data and the heart rate data respectively comprises: filtering the collected heart rate data to remove motion artifacts to obtain a real-time heart rate value, the real-time heart rate value comprising a maximum exercise heart rate, a minimum exercise heart rate, and a resting heart rate.

19. The electronic device as recited in claim 18, wherein in operation b, calculating the resultant acceleration, the resultant angular velocity, and the roll angle of the nine-axis inertial sensor, as well as the real-time heart rate value using the motion recognition algorithm based on the motion data and the heart rate data respectively further comprises: calibrating and filtering the collected motion data to obtain three-axis acceleration, three-axis angular velocity, and three-axis magnetometer data; fusing the three-axis acceleration, three-axis angular velocity, and three-axis magnetometer data to obtain the resultant acceleration, the resultant angular velocity, and a quaternion required for attitude calculation.

20. The electronic device as recited in claim 19, wherein in operation b, calculating the resultant acceleration, the resultant angular velocity, and the roll angle of the nine-axis inertial sensor, as well as the real-time heart rate value using the motion recognition algorithm based on the motion data and the heart rate data respectively further comprises: fusing the three-axis acceleration, three-axis angular velocity, and three-axis magnetometer data to obtain the resultant acceleration, the resultant angular velocity, and the quaternion required for attitude calculation; and converting the quaternion to obtain attitude angle, roll angle, and heading angle data.
